(19) United States
(12) Patent Application Publication
(10) Pub. No.: US 2003/0218364 A1
(43) Pub. Date: Nov. 27, 2003

(54) Interior panel

(76) Inventors: Bernd Glunk, Ebersberg (DE); Michael Behnke, Munchen (DE)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/348,197

(22) Filed: Jan. 21, 2003

(30) Foreign Application Priority Data
Jan. 21, 2002 (DE) 20200835.5

(51) Int. Cl. B60R 13/02

(52) U.S. Cl. 296/214

(57) ABSTRACT

An interior panel for a vehicle, such as a roof liner, includes at least one integrated stiffening and silencing layer. The interior panel is releasably fixed to the vehicle at least along substantially a periphery thereof at some peripheral fixing positions. Additional fixing positions are formed between the interior panel and, in particular, an outer panel of the vehicle by releasable and essentially linear and/or planar fixing means.

### CROSS REFERENCE TO RELATED APPLICATIONS

This application claims the benefit of German Application No. 20200835.5 filed Jan. 21, 2002.

### BACKGROUND OF THE INVENTION

The present invention relates to an interior panel for a vehicle, in particular a roof liner, comprising at least one integrated stiffening and silencing layer, the interior panel being releasably fixed to the vehicle at least along substantially a periphery thereof at some peripheral fixing positions.

Such an interior panel is e.g. described in DE 200047553, which is incorporated by reference herein, in its construction consisting of various layers. The stiffening and silencing layer is formed at least of a rigid carrier layer which is integrated into the interior panel. Moreover, the interior panel consists further of at least one decoration layer and an intermediate shock-absorbing layer.

Such an interior panel with an integrated stiffening and silencing layer may, in particular, be designed as an acoustic headliner when used as a roof liner. This designation points out that such an interior panel has an increased acoustic absorption and thus contributes to sound insulation in the interior of the vehicle to an enhanced extent. However, such a special construction of the roof liner is not needed according to the invention.

The interior panel is prefabricated as a rule and is mounted at a corresponding place of the vehicle. In particular, in the case of the roof liner, but also in the case of other interior panels, there is a fixation between vehicle and interior panel only along a periphery of the interior panel at corresponding peripheral fixing positions. In the case of the roof liner, such peripheral fixing positions are e.g. provided at places where grab handles or sun visors are mounted. The roof liner is here simultaneously fixed by fixing the grab handles or sun visors to the vehicle.

### BRIEF SUMMARY OF THE INVENTION

Starting from the already known interior panel described above, it is the object of the present invention to improve said panel while maintaining the former advantages such that the interior panel increases the stiffness of the corresponding outer panel of the vehicle with simple means and that thinner sheets can e.g. be used for the outer panel, whereby weight and costs are decreased.

In connection with the features of the preamble of claim 1, this object is achieved in that additional fixing positions are formed between interior panel and, in particular, outer panel of the vehicle by releasable and essentially linear and/or planar fixing means.

The additional fixing means yield an increased buckling resistance of the corresponding outer panel of the vehicle, so that a thinner sheet can be used for the outer panel. Since the fixing means is releasable for the additional fixing positions, the roof liner can further be disassembled without any destruction and reinstalled again. The further fixing positions ensure to an increased extent that the interior panel does not detach from the outer panel as a consequence of twists. For increasing the buckling strength of the outer panel of the vehicle, the fixing means is arranged in linear and/or planar fashion. A linear fixing means may be arranged in the longitudinal direction of the vehicle, in a transverse direction of the vehicle, in a direction diagonal to the vehicle or also in other directions and also in several directions. Likewise, the planar fixing means may also extend in one or a plurality of said directions and may be composed of one or several individual fixing means areas or strips.

Such a linear and/or planar fixing means can easily be realized in one embodiment of the invention in that the fixing means is e.g. designated as a releasable bonding agent.

The bonding agent can e.g. be applied during installation of the interior panel to corresponding places of the outer panel of the vehicle at the inside thereof facing the interior panel. When the interior panel is then fixed by the corresponding peripheral fixing positions to the vehicle, the fixing to the additional fixing positions can here also be carried out by the bonding agent.

However, in order to simplify the application of the bonding agent and to make the application reproducible with respect to the interior panel, the bonding agent can be applied in the form of an adhesive carrier at least to a back side of the interior panel facing the outer panel of the vehicle.

The fixing between adhesive carrier and interior panel or adhesive carrier and outer panel of the vehicle may take place in different ways. For instance, the adhesive carrier may be coated at at least one side with an adhesive agent or contain such an agent. Said adhesive agent serves to fix the adhesive carrier to the outer panel of the vehicle. Interior panel and adhesive carrier can be fixed in a different way. When the adhesive carrier is coated with adhesive agent at both sides, the respective connection is carried out via said adhesive agent.

Various methods are possible for applying the adhesive carrier to the interior panel. For instance, in order to interconnect the vehicle panel and adhesive carrier with adhesive agent already during carrier pressing of the interior panel, the adhesive carrier may be applied in the one-step method to the interior panel.

It is also possible to apply the adhesive carrier with adhesive agent only after the carrier pressing of the interior panel, so that a two-step method is used in such a case.

To apply the adhesive carrier subsequently in a simple way and at selected places to the interior panel, at least the adhesive agent can already be applied during carrier pressing of the interior panel, which corresponds to a mixing of one- and two-step methods.

Since the adhesive carrier can be applied in linear, strip-like and/or planar fashion, it can be regarded here as an advantage when the adhesive agent is designed as an adhesive film. It is then already defined by the arrangement of the adhesive film on the back side of the interior panel where and in which direction the adhesive carrier is applied subsequently, the adhesion of the adhesive carrier on the interior panel being ensured by the adhesive film. A further adhesive film can ensure the adhesion of the adhesive carrier to the outer panel of the vehicle. The adhesive film can here be adhesive on both sides. Instead of an adhesive film, the adhesive agent may also be designed as a powder-like adhesive, as an adhesive contained in the adhesive carrier, or the like. The corresponding adhesive agent may here be activated directly at the place of installation.

Instead of the use of an adhesive carrier with adhesive agent, it is also possible that the bonding agent is a so-called hotmelt. Said hotmelt can be applied, in particular, prior to the installation of the interior panel, either to said panel or also to the outer panel of the vehicle. When the application is carried out directly before installation, the bonding agent is already activated, i.e., in the bonding state. It is also possible to apply the adhesive agent already at an earlier time or to activate the same only directly before installation, e.g. by heating.

To be able to design the adhesive carrier in response to the respective requirements, said carrier may at least be formed of one carrier material. The carrier material can be chosen in accordance with the demands made on the adhesive carrier for compensating tolerances between the outer panel of the vehicle and the interior panel, for forming a predetermined breaking point, for ensuring the roof buckling resistance, etc. The adhesive or the adhesive agent can also be chosen in response to the respective requirements and the carrier material used and can also form a predetermined breaking point.

Examples of carrier materials which meet the corresponding demands are foam materials, based on polyurethane, polyolefin, or the like, non-woven fabric, paper, cardboard, paper/cardboard constructions, Velcro tape (hook and loop type mechanical fasteners), or the like, and/or two of said materials as a composite.

A permanently elastic and temperature-resistant adhesive may advantageously be chosen as the adhesive. Tolerances can also be compensated to some extent between interior panel and outer panel of the vehicle due to the permanent elasticity. Temperature resistance is in particular important in the case of a roof liner as an interior panel because upon insolation relatively high temperatures may arise on the outer panel of the vehicle. An example of an adhesive with such characteristics is a PSA (pressure sensitive adhesive).

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a basic illustration showing a section through a vehicle in the area of a roof liner as an interior panel; and

FIG. 2 is a section according to FIG. 1 in a second embodiment according to the invention.

### DETAILED DESCRIPTION OF THE INVENTION

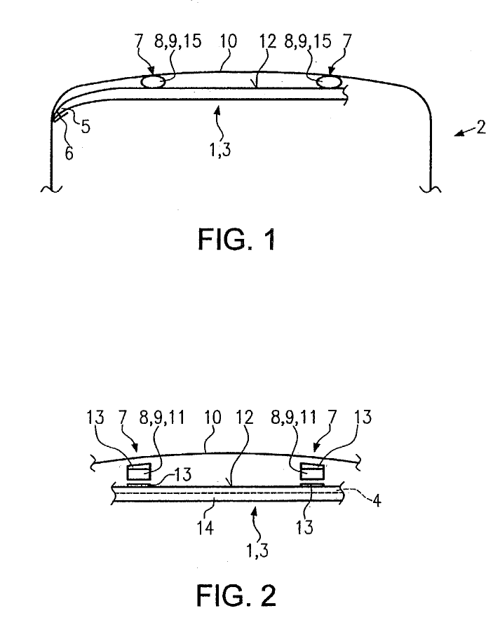

Referring now to the drawings, there is illustrated in FIG. 1 a basic illustration showing a section through a vehicle 2 in which a first embodiment of an interior panel 1 according to the invention is arranged in the form of a roof liner 3. The roof liner 3 extends both in the transverse and the longitudinal direction of the vehicle 1 and is detachably secured to the vehicle 2 along its periphery 5 at some peripheral fixing positions 6. The peripheral fixing positions 6 are in particular arranged in the area of grab handles, sun visors, or the like, the roof liner 3 being fixed together with the fixing of grab handles, sun visors, or the like.

The roof liner 3 contains an integrated stiffening and silencing layer 4 of the roof liner, see FIG. 2, in addition to further layers 14 facing the interior of the vehicle, e.g. a cushioning layer of foam material, or the like, and a decoration layer.

The stiffening and silencing layer 4 of the roof liner may also be composed of two or more layers.

For increasing the roof buckling resistance of an outer panel 10 of the vehicle 2, additional fixing positions 7 are provided between roof liner 3 and vehicle 2. Said fixing positions are linear, strip-like and/or planar.

In the embodiment according to FIG. 1, a fixing means 8 is applied to the corresponding fixing positions 7 in the form of a hotmelt 15 as a bonding agent 9. Said means is e.g. applied as an adhesive bead in the transverse direction, longitudinal direction, or also other directions of the vehicle to a rear side 12 of the roof liner 13 or to the outer panel of the vehicle.

The fixing means 8 is here applied on the site and prior to installation of the roof liner 3 directly onto said roof liner, and gluing is immediately carried out thereafter. The hotmelt may also be applied prior to installation, an activation of the hotmelt taking place during installation in this case. For the destruction-free disassembly of the roof liner, the connection interior panel/outer panel may be broken. A corresponding predetermined breaking point may be formed in this connection by the hotmelt.

In the second embodiment according to FIG. 2, the fixing means 8 is also designed as a bonding agent 9. In contrast to the embodiment according to FI G. 1, the bonding agent is however formed by an adhesive carrier 11 with adhesive agent. The adhesive carrier is made of a foam material, paper, cardboard, paper and/or cardboard constructions, of a non-woven fabric, Velcro tape (hook and loop type mechanical fasteners), or the like, or of a composite comprising at least two of said materials. The adhesive agent 13 is applied to the adhesive carrier 11 at one side or both sides, or is contained therein at least on the surface.

The adhesive agent 13 is designed as an adhesive film with PSA (pressure sensitive adhesive) for ensuring a permanently elastic and temperature-resistant connection.

The corresponding adhesive film can directly be used in a one-step method to join roof liner and adhesive carrier during carrier pressing.

It is also possible to use the adhesive film in a two-step method only after the carrier pressing of the roof liner for applying the adhesive carrier. The roof liner is here substantially free from a separating agent.

Finally, it is also possible to apply an adhesive film 13 at least to the back side 12 of the roof liner 3 already during carrier pressing and to fix the adhesive carrier 11 by said film to the roof liner at a later time. Such a possibility is outlined in FIG. 2.

A further adhesive film 3 or a further adhesive agent 13 is arranged on the adhesive carrier at its side facing the outer panel 10 of the vehicle.

The corresponding adhesive, which is in particular a PSA, can also be applied directly to the corresponding outsides of the adhesive carrier 11, so that a separate adhesive film can be dispensed with.

According to the invention it is ensured that tolerances between interior panel and outer panel of the vehicle are compensated by adhesive carriers with adhesive agents, the additional fixing positions 7 simultaneously guaranteeing the roof buckling resistance also when a thinner sheet is used for the outer panel of the vehicle. The bonding between interior panel and outer panel of the vehicle is here at least so firm that there are no detachments caused by twists. On the other hand, the connection is detachable so that the interior panel can be disassembled without destruction-and reinstalled again. If the roof liner is to be of a particularly simple construction and material and costs are to be saved further, it is also possible to form the roof liner substantially without any stiffening and silencing layer in that the remaining layers or the remaining layer of the roof liner is e.g. made slightly thicker. In this instance, the additional fixing means may be directly provided between the interior panel without stiffening and silencing layer and the outer panel of the vehicle. Depending on the material used for the layers of the interior panel, it is also possible that the above-mentioned adhesive carrier is made integral with one of said layers. This means, when e.g. the layer of the interior panel facing the outer panel of the vehicle is made from a material corresponding to the carrier material of the adhesive carrier, the adhesive carrier is formed by corresponding sections of said layer of the interior panel.

It is self-evident that in the case of a hotmelt as the bonding agent said agent can of course also be applied to an interior panel without a stiffening and silencing layer, as indicated above.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An interior panel for a vehicle having an outer panel comprising:
at least one integrated stiffening and silencing layer, said interior panel being releasably fixed to the vehicle at least along substantially a periphery thereof at some peripheral fixing positions, wherein additional fixing positions are formed between the interior panel and an outer panel of the vehicle by releasable and essentially linear and/or planar fixing means.

2. The interior panel according to claim 1, wherein said fixing means is designed as a releasable bonding agent.

3. The interior panel according to claim 1, wherein said bonding agent is applied in the form of an adhesive carrier at least to a back side of said interior panel facing the outer panel of said vehicle.

4. The interior panel according to claim 3, wherein said adhesive carrier is coated with an adhesive agent at least at one side.

5. The interior panel according to claim 3, wherein said adhesive carrier is applied in a one-step method to said interior panel.

6. The interior panel according to claim 3, wherein said adhesive carrier is applied in a two-step method to said interior panel.

7. The interior panel according to claim 2, wherein said adhesive agent is formed as one of an adhesive film, powder, web and hotmelt.

8. The interior panel according to claim 2, wherein said adhesive agent is applicable during carrier pressing of said interior panel.

9. The interior panel according to claim 2, wherein said bonding agent is applicable as a hotmelt, prior to the installation of said interior panel.

10. The interior panel according to claim 3, wherein said adhesive carrier is made at least of one carrier material and an adhesive.

11. The interior panel according to claim 3, wherein said carrier material is made of a foam material.

12. The interior panel according to claim 11, wherein said carrier material is selected from the group consisting of polyurethane and polyolefin.

13. The interior panel according to claim 1, wherein said carrier material is selected from the group consisting of non-woven fabric, paper, cardboard, paper/cardboard constructions, and Velcro tape.

14. The interior panel according to claim 3, wherein said carrier material is made of at least two materials as a composite selected from the group consisting of foam material, non-woven fabric, paper, cardboard, paper/cardboard constructions, and Velcro tape.

15. The interior panel according to claim 1, wherein an adhesive of said adhesive agent is a permanently elastic and temperature-resistant adhesive.

16. The interior panel according to claim 15, wherein said adhesive is a pressure-sensitive adhesive.

17. The interior panel according to claim 1, wherein the interior panel is a roof liner.

18. The interior panel according to claim 1, wherein said adhesive carrier contains an adhesive agent.
